(19) United States
(12) Patent Application Publication
(10) Pub. No.: US 2010/0094735 A1
(43) Pub. Date: Apr. 15, 2010

(54) METHODS AND SYSTEMS FOR AUTOMATED PAYMENTS

(76) Inventors: Charles Reynolds, Southport, CT (US); Edward J. Hogan, East Quogue, NY (US); Mary Jo Winterer, Norwalk, CT (US); James B. O'Connell, White Plains, NY (US); John Burkley, Briarcliff, NY (US)

Correspondence Address: BAKER BOTTS L.L.P., 30 ROCKEFELLER PLAZA, 44TH FLOOR, NEW YORK, NY, 10112-4498, US

(21) Appl. No.: 12/437,323

(22) Filed: May 7, 2009

Related U.S. Application Data
(63) Continuation-in-part of application No. 11/560,212, filed on Nov. 15, 2006.
(60) Provisional application No. 61/051,282, filed on May 7, 2008.

(51) Int. Cl. G06Q 20/00; G06Q 40/00; G06Q 30/00

(52) U.S. Cl. 705/34; 705/40

(57) ABSTRACT

Techniques for defining and customizing payment rules and automatically paying charges in accordance with the rules is described. A charge is settled and the charge is posted to an account, for example a credit card account, in the form of a settlement record. An automated payments engine compares the settlement record against payment conditions of one or more payment rules. If a payment condition is satisfied, the automated payments engine initiates a payment according to a payment method associated with the satisfied payment condition.

### CROSS REFERENCE TO RELATED APPLICATIONS

This application claims priority to U.S. Provisional Patent Application Ser. No. 61/051,282, filed on May 7, 2008 and entitled “Consumer Control Payment card,” which is incorporated by reference herein. This application is also a continuation-in-part of U.S. patent application Ser. No. 11/560,212, filed Nov. 15, 2006 and entitled “Financial Transaction Card With Installment Loan Feature,” which is incorporated by reference herein in its entirety. This application is related to U.S. Provisional Patent Application Ser. No. 61/086,913, filed Aug. 7, 2008 and entitled “A Method For Providing A Credit Cardholder With Multiple Funding Options,” which is incorporated by reference in its entirety.

### BACKGROUND

Merchants have increasingly made electronic payment facilities available, such as those allowing payment by credit card, debit card, direct debit, wire transfer, etc. Goods or services which have historically required payment via cash or paper check (e.g., rent, mortgage, and college tuition payments, and the like) may now be paid for via electronic payment methods.

Consumers also have access to more than one account from which to make payments, such as multiple checking/savings accounts, multiple credit cards, lines of credit (such as home equity loans), and the like.

Traditionally, charges, such as those posted to a credit card account, are billed and paid in aggregate at end of a periodic billing cycle. For example, a cardholder making purchases with a credit card from various merchants throughout a particular month may receive a statement from the credit card company at the end of the monthly billing cycle. The amount of the cardholder's line of credit associated with the account will therefore decrease as the month progresses, as each new purchase is applied to (and reduces) the line of credit, until a payment is received. The statement may include charges from different types of merchants and may include charges for small and large amounts. Payment cards, such as credit cards, provide the ability to centralize payments for easy review by the consumer. In order to prevent the accumulation of late fees or defaulting on the charges, the cardholder pays an amount of funds that is applied to the outstanding balance, regardless of the type or nature of the individual charges on the monthly statement.

However, consumers do not have the ability to customize, for example, when payments are made, from what account the charges are paid from, or the like. Therefore, some aspects of the present invention relate to devices and techniques to allow consumers to customize and centralize the payment of the various types of charges, providing more control over when and how payments are made in respect to transactions charged to their credit card account.

In other aspects, the present invention relates to a financial transaction payment method and system utilizing financial transaction cards, such as credit cards and debit cards, and to a financial transaction payment method and system involving installment loans, which are loans in which the loan amount and loan interest are repaid in a predetermined number of periodic payments, usually monthly.

Financial transaction cards have made great gains in the United States as a means to attract financial accounts to financial institutions and, in the case of credit cards, as a medium to create small loans and generate interest income for financial institutions. Nonetheless, the financial transaction card industry is subject to certain problems.

Taking the credit card industry, for example, the financial institutions issuing credit cards must constantly renew their card account base each year. Typically, in fact, a financial institution must increase its credit card account base by 10% to 12% each year to offset voluntary and involuntary card account transfers and closures. To realize these needed gains, financial institutions are constantly mailing credit card offers to consumers. Such offers usually contain incentives such as no annual fees, delayed payments, and favorable annual percentage rates (APR) to attract new cardholders.

Another consideration in the credit card industry is related to the unprofitability of carrying certain types of cardholders. The credit card account base of a financial institution is typically characterized as having two types of cardholders: pay-in-full cardholders (those cardholders that pay their statements in full in each billing cycle) and roll-over cardholders (those cardholders that do not pay their statements in full in each billing cycle, but roll over some of their payments to subsequent billing cycles). On average, the typical account base of a financial institution consists of 25% of pay-in-full cardholders and 75% of roll-over cardholders. Currently, the profitability of the account base of a financial institution is almost entirely attributable to the revenue generated from the interest income from the roll-over cardholders. Nonetheless, the pay-in-full cardholders generate about 50% of the sales activity of the account base. Because of the cost of funds and the lack of receipt of annual fees, the pay-in-full cardholders are a great expense for financial institutions.

Currently, the installment lending market is many times larger than that of the financial transaction card market. Consumers typically use installment loans for paying for such items as travel and large home appliances. Advantageously, by providing a account holder with the ability to obtain an installment loan using a financial transaction card, a financial institution is able to leverage an existing financial account (the financial transaction card account) to provide another service to the account holder. In other words, by providing the convenience of obtaining an installment loan through a financial transaction card account, a account holder is less likely to obtain such a loan from another financial institution.

Because of the size of the installment lending market, it is expected that significant revenue will be generated for a financial institution providing installment loans through financial transaction cards. Moreover, the convenience of obtaining an installment loan through a financial transaction card may also be used as a strong incentive to lure new account holders to a financial institution and, thus, increase the financial institution's financial transaction card account base.

### SUMMARY

Some embodiments of the present invention include a system for automatically processing payment transactions using a credit card account having a periodic billing cycle, including an accountholder interface configured to receive automated payment configuration data from an accountholder associated with said credit card account, said configuration data including at least one payment condition and at least one payment method associated with said payment condition, an account transaction settlement database storing at least one settlement record, said settlement record corresponding to a payment transaction performed using said credit card account, and an automated payments engine executed on one or more computer processors, coupled to said accountholder interface and to said account transaction settlement database, said automated payments engine configured to determine whether said payment transaction satisfies said payment condition and to automatically initiate payment for said transaction using said at least one payment method before the end of said periodic billing cycle, when the result of said determining is that said payment condition is satisfied.

In some embodiments, the payment may be cancelled and the transaction may be included in the next periodic billing statement when a payment method account of the payment method has insufficient funds to cover the payment. The credit card account may be a credit account and the associated credit limit of the payment account may not be reduced when the payment is completed.

Payment conditions include a condition based on when a payment transaction occurred, the type of goods or services purchased, the type of merchant from which goods were purchased, the amount of funds remaining in a payment method account of the payment method, the amount of a payment transaction, the type of currency used to pay for goods, or any combination thereof. Payment conditions may include more than one subcondition, and payment methods may include more than one submethod.

The payment method account of the payment method may be maintained at the same banking institution as the credit card account or maintained at a different banking institution as the credit card account. The payment from the payment method account maintained at a different banking institution may be made using an automated clearing house.

Some embodiments include procedures for processing payment transactions using a credit card account having a periodic billing cycle, including receiving, at a configuration server, automated payment configuration data from an accountholder associated with said credit card account, said configuration data including at least one payment condition and at least one payment method associated with said payment condition, storing, in an account transaction settlement database, at least one settlement record, said settlement record corresponding to a payment transaction performed using said credit card account, and processing said at least one settlement record using an automated payments engine in accordance with said automated payment configuration data to determine whether said payment transaction satisfies said payment condition and to automatically initiate payment for said transaction using said at least one payment method before the end of said periodic billing cycle, when the result of said determining is that said payment condition is satisfied.

In accordance with some embodiments of the present invention, there is provided a financial transaction payment system for processing a transaction conducted using a financial transaction card. The financial transaction card has associated therewith a financial account with a financial institution and one or more transaction criteria. The financial transaction payment system includes a processing unit; an application program for execution on the processing unit; and means for determining by the application program whether the transaction accesses an installment loan on the financial account based on the one or more transaction criteria.

Devices and techniques for automatically processing payment transactions are also described.

In some embodiments, the present invention provides a system and method for accessing automatically an installment loan based on certain transaction criteria associated with transactions involving a financial transaction card.

In accordance with an embodiment of the present invention, there is provided a method of conducting a transaction using a financial transaction card in a financial transaction payment system. The financial transaction payment system includes a processing unit and an application program executing on the processing unit. The financial transaction card has associated therewith a financial account in a financial institution and one or more transaction criteria. The method includes the step of determining by the application program whether the transaction accesses an installment loan on the financial account based on the one or more transaction criteria.

In one embodiment, the financial account has an associated available installment loan credit amount. The method of the present invention then further includes the step of determining by the application program whether the amount of the transaction is greater than the available installment loan credit amount. In addition, the method may also include the step of decreasing by the application program the available installment loan credit amount by the amount of the transaction if the amount of the transaction is less than or equal to the available installment loan credit amount.

It is also preferred that the financial transaction card has associated therewith a primary financial payment function other than accessing an installment loan. For example, the primary financial payment function may be a credit payment function or a debit payment function. In such a case, the method of the present invention also includes the step of processing the transaction by the application program in accordance with the primary financial payment function if the transaction does not access an installment loan on the financial account.

In accordance with another embodiment of the present invention, a method of authorizing a transaction between a consumer and a merchant is also provided. The consumer has a financial transaction card issued by an issuing financial institution, the financial transaction card having associated therewith a financial account with the financial institution, one or more transaction criteria, a primary financial payment processing procedure, and an installment loan processing procedure. The method includes the step of processing an authorization request by the application program using the primary financial payment processing procedure or the installment loan processing procedure depending on whether or not the transaction criteria are met.

Optionally, the method further includes the step of requesting authorization by the merchant from a financial transaction card processing entity that is in electronic communication with the issuing financial institution before the processing step. In addition, the method may further include the steps of capturing by the merchant the transaction if an authorization is received in response to the authorization request, and transmitting by the merchant the captured transaction to the financial transaction card processing entity. In addition, the method may also include the step of settling the transaction by the financial transaction card processing entity with the merchant and the financial institution.

In accordance with yet another embodiment of the present invention, there is also provided a method of setting up an account associated with a financial transaction card of a consumer, which may be used to access one or more installment loans for the payment of one or more transactions. The method is used in connection with a financial transaction payment system that includes a processing unit, an application program for execution on the processing unit, and a memory unit coupled to the processing unit. The method includes the steps of storing by the application program in the memory unit a credit limit for the one or more installment loans that may be accessed with the financial transaction card, and storing by the application program in the memory unit one or more criteria for accessing the one or more installment loans with the financial transaction card. The criteria may include the type of a transaction, the amount of a transaction, and the merchant classification code associated with a merchant involved in a transaction.

One embodiment includes the step of storing by the application program in the memory unit payment terms for the one or more installment loans that may be accessed with the financial transaction card. The method may further include the step of storing by the application program in the memory unit an available credit amount for the one or more installment loans that may be accessed with the financial transaction card.

In accordance with yet another embodiment of the present invention, there is provided a method of preparing a statement for transactions conducted using a financial transaction card and stored in the memory unit of a financial transaction processing system, as described above. Each transaction is associated with either a primary financial payment procedure or an installment loan payment procedure. The method includes the steps of: (a) determining by the application program the totals of the transactions associated with the primary financial payment procedure; (b) determining by the application program the totals of the transactions associated with the installment loan payment procedure; and (c) printing by the application program the totals of the transactions associated with the primary financial payment procedure and the totals of the transactions associated with the installment loan payment procedure on the statement.

In accordance with yet another embodiment of the present invention, there is provided a method of processing a payment for a financial transaction card account, the financial transaction card account having an associated installment loan balance and an associated credit balance. The method includes the steps of determining by the application program whether the payment is less than the installment loan balance, and processing by the application program a cash advance against the credit balance equal to the difference between the payment and the installment loan balance, if the payment is less than the installment loan balance.

### BRIEF DESCRIPTION OF THE DRAWINGS

FIGS. 1A and 1B are flowcharts illustrating the steps for setting up a financial transaction card account with an installment loan feature according to a preferred embodiment of the present invention;

FIG. 2 is a flowchart illustrating the steps for processing a transaction in a financial transaction card system with an installment loan feature according to a preferred embodiment of the present invention;

FIGS. 3A and 3B are flowcharts illustrating the steps for processing a statement in a financial transaction card system with an installment loan feature according to a preferred embodiment of the present invention; and

FIGS. 4A and 4B illustrate a statement produced by a financial transaction card system with an installment loan feature in accordance with a preferred embodiment of the present invention;

FIG. 5 illustrates a block diagram of exemplary components according to some embodiments of the described subject matter;

FIG. 6 depicts a block diagram of an exemplary embodiment of an automated payments engine of FIG. 1;

FIG. 7 depicts a block diagram of exemplary components according to some embodiments of the described subject matter;

FIG. 8 depicts a flowchart of an exemplary procedure according to some embodiments of the described subject matter;

FIG. 9 illustrates exemplary components according to some embodiments of the described subject matter

FIG. 10 depicts a flowchart of an exemplary procedure according to some embodiments of the described subject matter.

### DETAILED DESCRIPTION

The present invention is related to a financial transaction card payment system, such as a credit card payment system using the MasterCard® Interchange. The MasterCard® Interchange is a proprietary communications standard promulgated by MasterCard International Incorporated® for the exchange of financial transaction data between financial institutions that are members of MasterCard International Incorporated®

In a typical financial payment system, a financial institution called the “issuer” issues a financial transaction card, such as a credit card, to a consumer, who uses the financial transaction card to tender payment for a purchase from a merchant. To accept payment with the financial transaction card, the merchant must normally establish an account with a financial institution that is part of the financial payment system. This financial institution is usually called the “merchant bank” or the “acquiring bank.” When the account holder tenders payment for a purchase with a financial transaction card, the merchant requests authorization from the merchant bank for the amount of the purchase. The request may be performed over the telephone, but is usually performed through the use of a point-of-sale terminal, which reads the account holder's account information from the magnetic stripe on the financial transaction card and communicates electronically with the transaction processing computers of the merchant bank. Alternatively, a merchant bank may authorize a third party to perform transaction processing on its behalf. In this case, the point-of-sale terminal will be configured to communicate with the third party. Such a third party is usually called a “merchant processor” or an “acquiring processor.”

Using the interchange, the computers of the merchant bank or the merchant processor will communicate with the computers of the issuer to determine whether the account holder's account is in good standing and whether the purchase is covered by the account holder's available credit line. Based on these determinations, the request for authorization will be declined or accepted. If the request is accepted, an authorization code is issued to the merchant.

In some embodiments, when a request for authorization is accepted, the available credit line of the account holder's account is decreased. In some embodiments, a charge may not be posted immediately to an account holder's account because bank card associations, such as MasterCard International Incorporated,® have promulgated rules that do not allow a merchant to charge, or “capture,” a transaction until goods are shipped or services are delivered. When a merchant ships or delivers the goods or services, the merchant captures the transaction by, for example, appropriate data entry procedures on the point-of-sale terminal. If a consumer cancels a transaction before it is captured, a “void” is generated. If a consumer returns goods after the transaction has been captured, a “credit” is generated.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which are settled as a group.

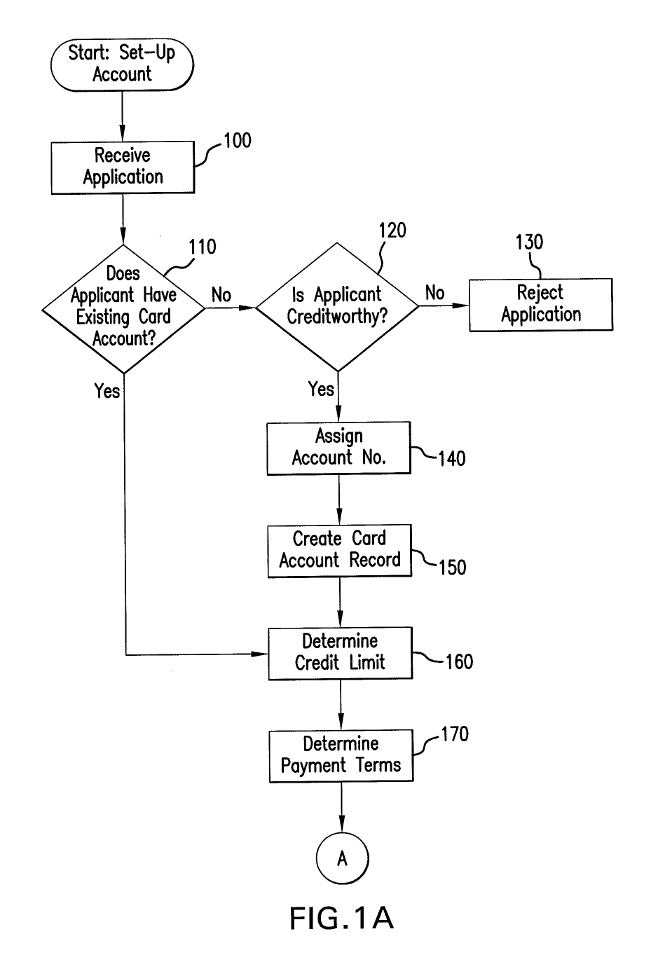

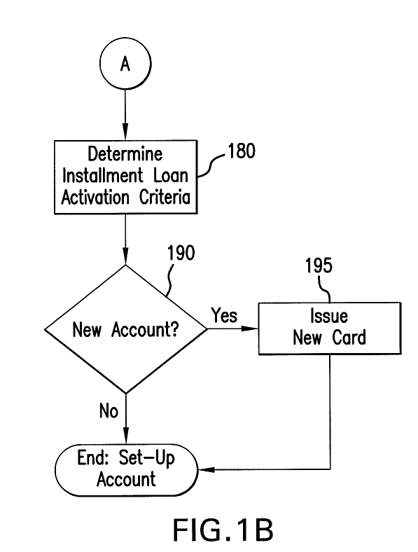

FIGS. 1A and 1B are flowcharts illustrating the steps for setting up a financial transaction card account with an installment loan feature according to a preferred embodiment of the present invention. In step 100, an issuer financial institution receives an application from an entity desiring to obtain a financial transaction card account having an installment loan feature. In one example, there may be three installment card types. One type is the “stand alone” version, in which the account holder acquires a new financial transaction card specifically designed for large purchases to be paid over a fixed period of time. All purchases on this financial transaction card will install. The stand alone version may serve as a companion card to a primary card, which would preferably be a conventional revolving credit card without the installment capability.

A second type may be, for example, a financial transaction card with an “add-on/upgrade” option. In this type of installment card, the account holder may add the installment feature to an existing financial transaction card, expanding the functionality of the existing card to cover both revolving credit and installment (i.e., fixed payment) options. A third type may be, for example, an “all-in-one” option. In this option, an account holder acquires a new financial transaction card that both revolves and has installment options.

The applicant may be an individual consumer, or may be a business, or may also be any other entity or organization. The financial transaction card account having an installment loan feature may be linked to a physical card, such as a conventional credit card, debit card, smart card, etc. Alternatively, the account may not be linked to a physical card at all, but may be linked instead to a non-physical electronic or “virtual” card suitable for use in, for example, electronic commerce transactions.

A virtual financial transaction card account, in accordance with an example of the present invention, is preferably a “card-optional” account. That is to say, a virtual card account need not be issued with a physical card. The virtual financial transaction card account may, for example, be linked to a physical financial transaction card account such that the existence of the virtual financial transaction card is dependent on the existence of the physical financial transaction card account. That is to say, in this exemplary embodiment if the physical card account is cancelled, the virtual card account is also cancelled. Alternatively, the account holder may be have the option of receiving a physical card that is linked to the virtual financial transaction card account. The physical card may, but need not, have the same account number as the virtual financial transaction card account.

In step 110, the financial institution determines, by reviewing the application and its account holder database, whether the account applicant has an existing financial transaction card account. If the applicant does not have an existing financial transaction card account, in step 120, the financial institution determines, by well-established financial industry guidelines, whether the account applicant is creditworthy. If the applicant is not creditworthy, the application is rejected in step 130. If the applicant is determined to be creditworthy, in steps 140 and 150, a financial transaction card account number is assigned to the applicant—now an account holder—and a financial transaction card account record is created in the financial institution's database. The card account record includes such information as the account holder's financial transaction card account number, name, address, and payment balances. The financial transaction card account record may also indicate whether the financial transaction card (whether virtual or physical or both) is linked to, for example, a consumer account or a business account.

In step 160, for both new and existing card accounts, the financial institution determines a credit limit for the account holder. In accordance with an exemplary embodiment of the present invention, the credit limit will preferably apply to the account holder's total combined purchases, regardless of whether those purchases were made using the financial transaction card's (whether physical or virtual) installment loan feature, or using a revolving line of credit. Alternatively, separate credit limits may be determined for the account holder's installment credit purchases, and conventional revolving credit purchases. In either case, the credit limit is preferably determined by well-established industry guidelines based on the account holder's credit history.

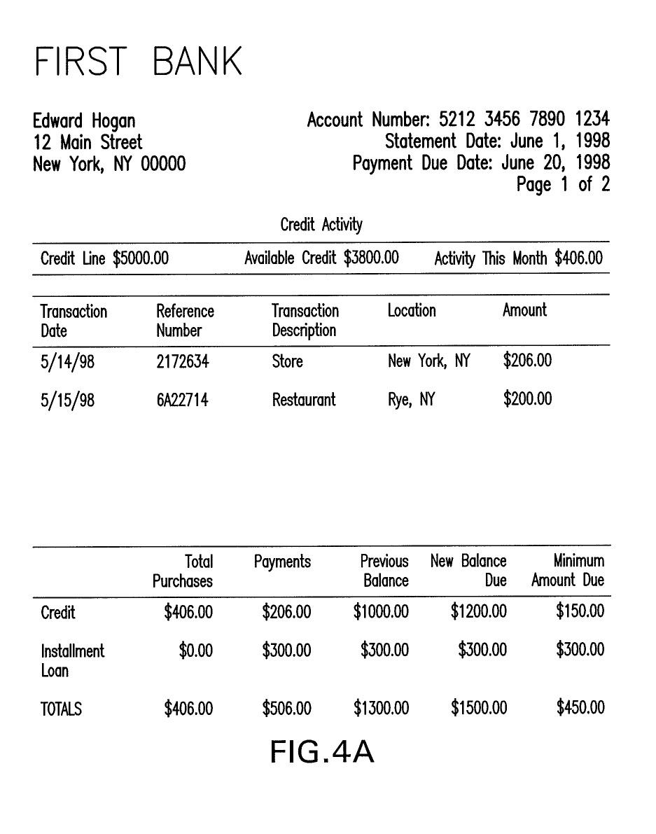

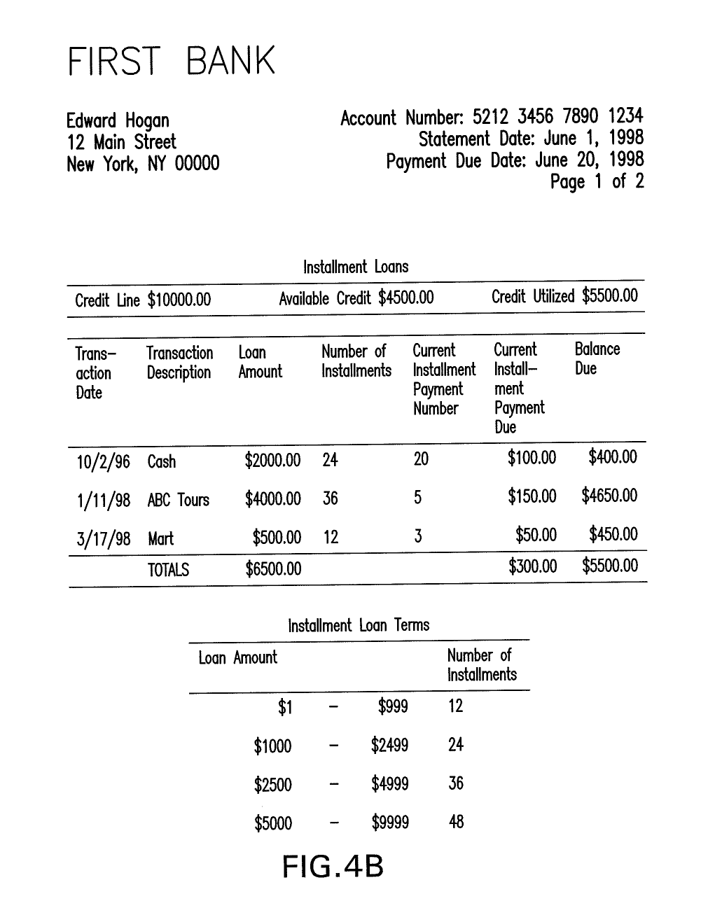

In step 170, the payment terms for installment loans accessed using the installment loan feature of the virtual and/or physical financial transaction card are determined. As illustrated in FIG. 4B, the payment terms may include a predetermined number of installment payments based on a range of loan amounts. In addition, the payment terms may include predetermined interest rates based a range of loan amounts (not illustrated). The payment terms may be established generally by the financial institution for all account holders or may be established by the financial institution on an account holder by account holder basis depending on an account holder's credit history. The financial institution may also allow the account holder to select certain payment term options on the application form (such as the number of installment payments for a loan range).

Referring to FIG. 1B, in step 180, the financial institution determines the installment loan criteria for the virtual and/or physical financial transaction card account. The installment loan criteria, when met, trigger the installment loan processing of a purchase made with the financial transaction card, as opposed to the processing of the purchase based on revolving credit. The installment loan criteria may include, for example, the type of a transaction (e.g., cash advance), the dollar amount of a transaction, or the merchant classification code of the merchant involved in a transaction. The installment loan criteria may also include whether a request has been made for a balance transfer, which may itself be triggered by the use of a convenience check, by a phone call requesting a balance transfer, or by a batch transmission from the issuer. These criteria may be specified by the financial institution or may alternatively be selected by account holders. In addition, there may be more than one criterion associated with a financial transaction account that triggers an installment loan. A default criterion, such as “No Installment Loans,” may also be established for those account holders that do not wish to take advantage of the installment loan features available with their cards.

Preferably, the determinations made in steps 160, 170, and 180 are stored in the account holder's account record. In steps 190 and 195, if a new financial transaction card (virtual and/or physical) account has been created, a new physical and/or virtual card may be issued to the account holder.

A financial transaction card account having the installment loan feature (whether physical, virtual, or both) may be tied to one or more different installment loans, each with separate rates and terms. That is to say, each purchase made by account holder using the financial transaction card (whether physical or virtual) may not only be for a different amount, but may also carry a different minimum monthly payment and a different interest rate. For example, referring to FIG. 4B, an account holder may make one purchase at ABC Tours, and a second purchase at Mart using the installment feature of the financial transaction card. The purchase from ABC Tours may, for example, be paid at $150.00 a month for 36 months at a rate of 6%, and the purchase at Mart may be paid at $50.00 a month for 12 months at a rate of 8%. These purchases along with revolving credit purchases may appear on one monthly financial transaction card statement and the amount due may be combined into a single minimum monthly payment.

A financial transaction card account having the installment loan feature (whether physical, virtual, or both) may also be linked to a primary account or credit line that is shared by a group of persons such as, for example, a family. In this example, a primary account holder (e.g., the head of the household) and the sub-account holders (e.g., the head of household's children) would each have an assigned credit limit. In the example of a family, for example, an overall credit line for the family's primary account may be $10,000. The primary account holder, who may be the head of the household, may have an assigned credit limit of $7,000, while each of the primary account holder's two children may be sub-account holders, each having a $1,500 limit. Each sub-account holder may, for example, have a physical or virtual financial transaction card with its own separate card number that is linked to the number of the primary account holder's account, with the activity and account status of the primary account holder and each of the sub-account holders being summarized in a billing statement. The primary account holder could optionally set up the sub-account such that some or all of the purchases made using the sub-account numbers will install. This is a useful tool for parents wishing to instruct their children in responsible use of financial transaction cards and budgeting as each sub-account holder would know the exact amount of his or her monthly payment, and exactly how long it will take to pay the account off in full.

In another exemplary embodiment of the financial transaction card having an installment loan feature according to the present invention, a business may set up an installment card account as a “lodged account.” A lodged account may be, for example, a virtual corporate card account that is “lodged” with one of the business' vendors. For example, a business may prefer that the travel expenses of its employees be billed to it through its travel agency. Such a business may lodge its financial transaction card account with the travel agency, causing all of the business' travel costs for one or more employees to be billed to that account, or to multiple accounts linked to a primary financial transaction card account. In accordance with an example of the present invention, a financial transaction card having an installment loan feature could be lodged with a vendor, such as (but not limited to) a travel agency, with certain installment triggers set up, e.g., a merchant category trigger to have all airfare and hotel purchases install.

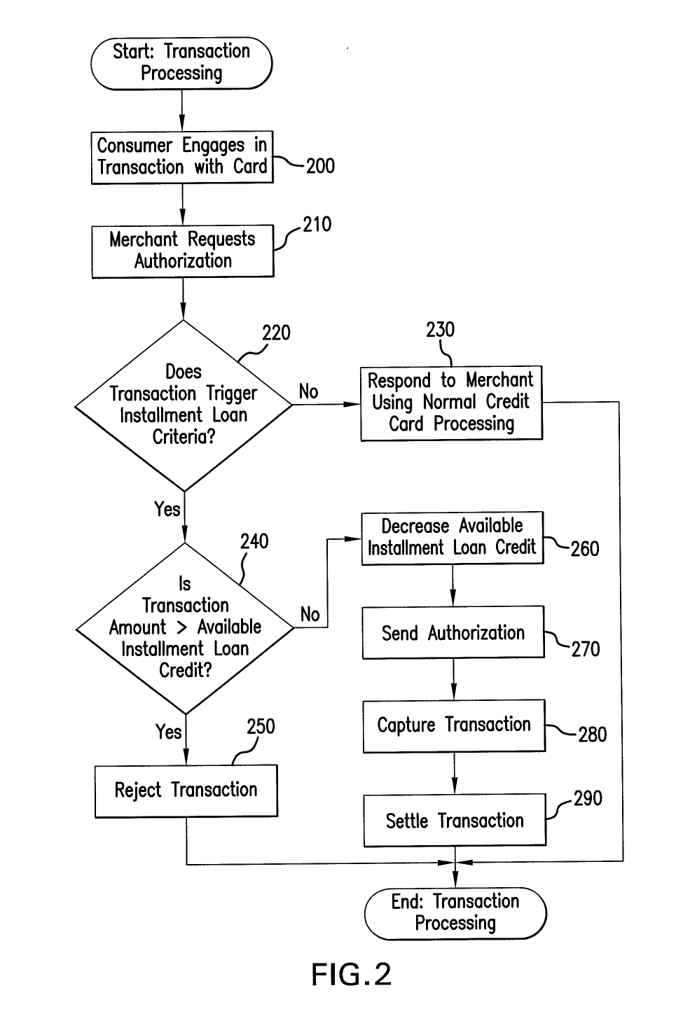

FIG. 2 is a flowchart illustrating the steps for processing a transaction in a financial transaction card system with an installment loan feature according to a preferred embodiment of the present invention. In step 200, an account holder engages in a transaction with a physical and/or virtual financial transaction card having the installment loan feature. In step 210, the merchant engaged in the transaction requests authorization for the transaction from the merchant bank or its agent. The merchant bank or its agent communicates the request to the interchange or the issuing financial institution or its agent.

In step 220, the interchange or the financial institution or its agent determines whether the transaction triggers one or more of the criteria for installment loan processing specified for the financial transaction card account of the account holder. In step 230, if the transaction does not trigger any of the criteria for installment loan processing, normal financial transaction card processing is performed—i.e., the financial institution or its agent accepts or rejects the transaction based on at least a determination of whether the transaction would exceed the credit line of the financial transaction card account. If one or more of the criteria for installment loan processing is triggered, in step 240 the interchange or the financial institution or its agent determines whether the transaction amount is greater than the available installment loan credit amount, which is equal to the installment loan credit limit minus the total installment loans balances due for the financial transaction card account. If the transaction amount exceeds the available installment loan credit amount, the transaction is rejected in step 250. Alternatively, if the transaction amount exceeds the available installment loan credit amount, the transaction may be accepted or rejected under normal financial transaction card processing procedures. If the transaction amount does not exceed the available installment loan amount, in steps 260 and 270, the available installment loan credit amount is decreased by the transaction amount and the transaction is accepted by sending an authorization code to the merchant.

It should be noted that in steps 260 and 270, the authorization reduces the available credit amount but preferably does not actually put a charge on the account holder's account. It is preferred that a account holder's account is not charged during authorization because bank card associations, such as MasterCard International Incorporated®, have promulgated rules that do not allow a merchant to charge or capture a transaction until goods are shipped or services are delivered. Thus, it is preferable for the charging or capturing process to be performed separately in step 280. After the charging or capturing step, settlement occurs in step 290. As explained above, transactions are usually captured and accumulated into a “batch,” which are then settled as a group.

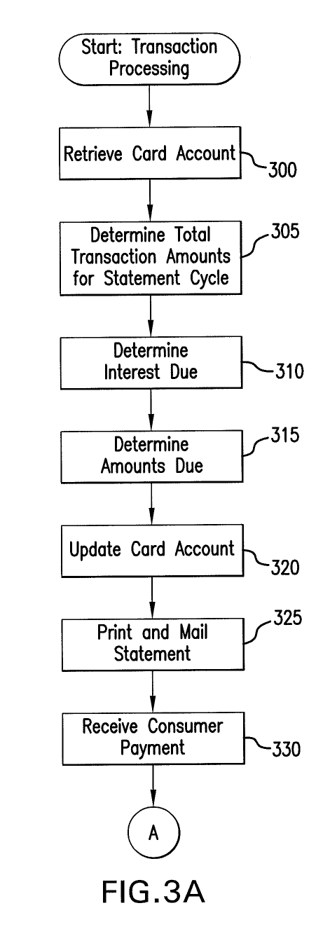

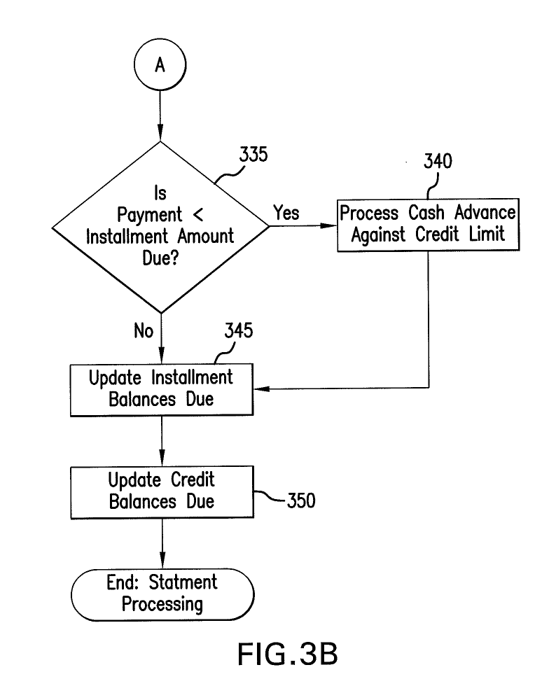

FIGS. 3A and 3B are flowcharts illustrating the steps for processing a statement for a financial transaction card with an installment loan feature according to a preferred embodiment of the present invention. The statements are typically processed on a monthly basis. In step 300, the card account record is retrieved from the financial institution's database. In step 305, the transactions that have been captured for the card account, both on a credit and on an installment loan basis, are totaled. In step 310, the interest due on previously unpaid credit balances and on new installment loans is calculated. In steps 315 and 320, the new amounts due on both credit and installment loan activities are calculated and the card account record is updated.

In step 325, the statement is printed and mailed. FIGS. 4A and 4B illustrate a preferred embodiment of a statement produced by a financial transaction card system according to the present invention. As shown, the statement lists a summary of the credit and the installment loan activities on the first page. The statement lists a detailed description of the credit and the installment loan activities on the first and second pages, respectively. As shown in FIG. 4B, for each loan, the detailed description of the installment loan activity preferably includes the date of the loan, the description of the loan, the loan amount, the total number of installment payments due, the current installment payment number, the current installment payment amount due, and the total installment loan balance due. In addition, it is also preferred that the installment loan terms are listed on the same page as the detailed description of the installment loan activity to remind the account holder of these terms.

Returning to FIG. 3A, in step 330, after mailing the statement, a payment is received from the account holder. Referring to FIG. 3B, in step 335, it is determined whether the payment received is less than the installment loan amount due. If the payment is less than the installment loan amount due, a cash advance in the amount of the difference between the payment received and the installment loan amount due is preferably charged against the account holder's credit line in step 340. Alternatively, payment collection procedures may be implemented in this step.

If a sufficient payment is received in step 335 or a deficiency is processed in step 340, in step 345 the installment loan balances are updated to reflect the payment. In step 350, any payment amount received above the installment loan amount due is applied against the credit balance due. In steps 345 and 350, the card account record is updated accordingly.

In some alternate embodiments, generally, techniques for defining and customizing payment rules and automatically paying charges in accordance with the rules is described. In some purchase card transactions, a customer presents a purchase card to a merchant when the customer wishes to purchase goods or services. In some instances, the transaction may occur in a physical store, such as when a customer presents a physical purchase card to a cashier at a point-of-sale (“POS”) terminal. In some cases, the transaction may occur remotely, such as when a customer fills out a purchase form on a website. In other cases, the customer may provide a purchase card number and other identifying information to a customer service representative over the phone. Still further, a customer may set up an automatic charge with a banking institution (such as the customer's checking account bank or a vender) to charge goods or services to the customer's card automatically (such as automatic monthly payments for monthly billed services).

The merchant then contacts an acquirer and presents the purchase card information to the acquirer. The acquirer either authorizes or denies the transaction, for example, based on the customer's credit limit, credit worthiness, etc. If the transaction is denied, the customer may be required to pay for the goods or services in an alternate way, such as with cash. If the transaction is authorized, the acquirer notifies the merchant who authorizes the sale to the customer. The acquirer then settles the transaction with the customer's card issuing bank and deposits the appropriate funds in the merchant's account.

The card issuing bank then places a charge on the customer's account (i.e., posts the charge) and presents the charge to the customer in the next billing statement. Other techniques for charging, authorizing, and settling transactions may be used as appropriate.

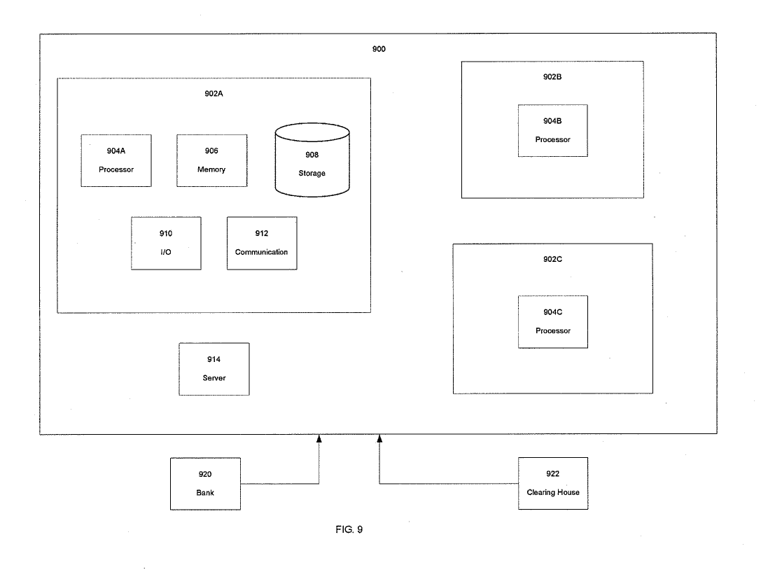

Techniques of the presently described subject matter may be incorporated into general purpose or special hardware for carrying out the described techniques. For example, as shown in FIG. 9, a computing platform 900 may include one or more computing devices (e.g., servers or standalone computers) 902a-c, each including one or more processors 904a-c. The processors 904a-c may include general purpose processors, special purpose hardware, firmware, or the like. The processors 904a-c may include serial instruction or parallel processors. In some embodiments, the processors 904a-c may be specially configured with instructions to carry out one or more procedures for the automated payments of the described subject matter. For example, the processors 904a-c may be configured to execute the instructions for an automated payments engine (described below). In some embodiments, the computing devices 902a-c may be suitably linked over a computer network and may function to cooperatively carry out one or more procedures of the described subject matter.

The computing devices 902a-c may include one or more memory devices 906, data storage devices 908, input/output devices 910, and communication devices 912 (such as network interfaces). Data storage devices 908 may include devices for storing data for the described techniques (e.g., transaction data, account information, user authentication information, etc.) and/or instructions for directing one or more of the processors 904a-c to carry out the described techniques. The data storage devices 908 may include hard disks, firmware, EPROM devices, flash memory devices, media devices (such as CD or DVD drives), or the like. Instructions for carrying out the described techniques may be stored on any appropriate storage medium, including local or remote hard disks, CDs, DVDs, flash memory, EPROM, special integrated circuits, firmware, and the like. In some embodiments, the processors 904a-c may be configured with one or more instructions to carry out the described subject matter, such as reading the instructions from a computer readable medium. Computer readable media may include CDs, DVDs, hard disks, firmware, flash memory, and the like.

The computing platform 900 may include a server application 914 for transmitting and receiving data from one or more connected entities. The server application 914 may generate data capable of being displayed on a screen at a remote entity, such as to provide functionality for user configuration of one or more aspects of the described techniques. Server application 914 may be, for example, a web server application.

The computing platform 900 may be in communication with one or more entities, such as bank platforms 920, financial transaction clearing houses 922, and other entities to exchange data related to financial transactions. The communication platform may include general purpose data networks, such as wide area networks or point-to-point networks, or may include specialized networks, such as Mastercard's® payment network.

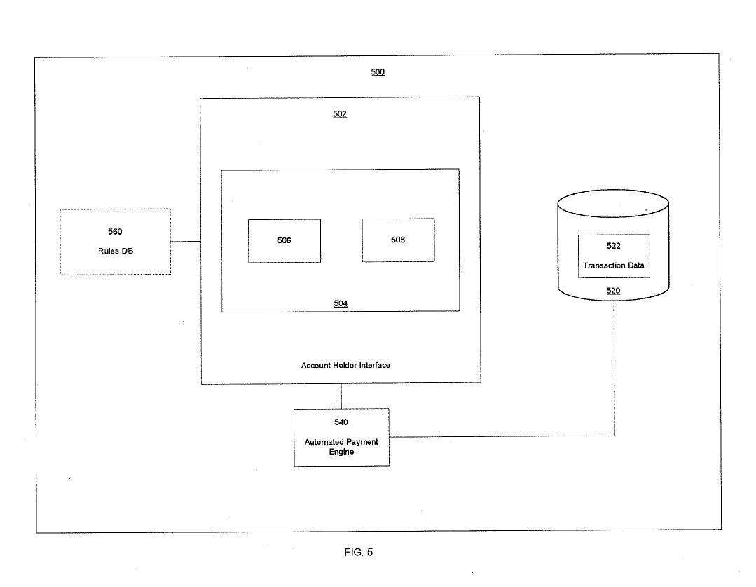

FIG. 5 depicts a block diagram of an exemplary payment transaction processing system of the described subject matter. Payment transaction processing system 500 may be configured to automatically pay a cardholder's card charges based on one or more configured rules. For example, a cardholder may specify that all charges below a certain dollar amount (e.g., $20) are to be automatically paid from the cardholder's checking account. The payment transaction processing system, detecting the satisfaction of such a payment condition (i.e., charge less than $20) by a charge transaction, may pay the charge using the payment method (paying from the cardholder's checking account). In another example, a cardholder may specify, in another rule, that all charges from home improvement, home goods, and construction contractors should be automatically paid from the cardholder's home equity line of credit account, regardless of the amount.

Payment transaction processing system 500 may include an accountholder interface 502, transaction database 520, and automated payments engine 540. The accountholder interface 502 may include one or more applications for allowing a cardholder to configure one or more rules using automated payment configuration data 504. The automated payment configuration data 504 may include data for one or more payment conditions 506 and data for one or more payment methods 508. In some embodiments, the one or more interface applications may retrieve rules data from the rules database 560, package them for display, and transmit the packaged data to a remote location for display by the cardholder's display device (not shown). The remote cardholder may update the rule, generating automated payment configuration data, which is received by the accountholder interface 502. Alternatively, the cardholder may create a new rule using a rules application, thereby generating automated payment configuration data, which is received by the accountholder interface 502 and used to create a corresponding, new payment rule.

For example, the accountholder interface 502 may include a web server capable of packaging rules data as a standard web page and delivering the web page over a wide area network using the HTTPS protocol. The accountholder may request information using the HTTP Get method and may submit updated rules data to the accountholder interface 502 via HTTP Post methods. Alternatively, the accountholder interface 502 may implement one or more Javascript functions and may transmit and retrieve the rules data as appropriate. In other embodiments, the accountholder interface may include one or more CGI scripts, Java server pages, Java applets, etc., which may interact with the cardholder's display device as appropriate.

The rules database 560 may store one or more rules for one or more cardholders for access by the cardholder(s). For example, the rules database may include a rules table for each cardholder. Each table may include fields, one field for each attribute of a payment condition or a payment method of a payment rule. For example, payment conditions may be specified based on transaction cost, vender type, type of goods purchased, transaction date, etc. Payment methods may be specified based on a flag specifying whether the transaction should be automatically paid or billed monthly, number of days to wait before paying transaction, Bank ID, account ID, authentication data, and the like. The rules tables may include a field for each of these attributes. Alternatively, the rules may be constructed using a rules grammar which may result in the rules data being a string (such as field/value pairs specified in forms data in the HTTP protocol). In this case, the rules table may include a single field for storing the rule data. For example, for the rule, “automatically pay transactions less than $20”, the rules data may include payment condition fields “dollar amount”=20 and “above or below”=below. The payment method fields may include “automatic”=y “bank ID”=123 (ID of cardholder's main bank), and “Account ID”=456 (account ID of checking account).

The transaction database 520 may store transactions posted to the cardholder's card account, such as settled transaction 522. The transaction data may include one or more attributes that overlap with the payment conditions fields of the rules data. For example, the transaction data may include a dollar amount attribute.

The automated payments engine 540 may apply the payment rules from the rules database 560 to the transaction data from the transaction database 520. If the transaction data satisfies a payment condition of a payment rule, the automated payments engine 540 may cause a payment to be made according to the payment method associated with the payment condition. The automated payments engine 540 may be in communication with one or more financial institutions, such as the cardholder's checking account bank, home equity line of credit bank, trust account bank, and the like over a payment network, such as the Mastercard® payment network. When initiating a payment method which includes instructions to pay a charge using funds from one of the cardholder's accounts, the automated payments engine 540 may send a message to the appropriate cardholder bank, instructing the bank to transfer funds from the identified account to the card issuer's bank and to deposit the funds into the card issuer's account. For example, the message may conform to the Secure Electronic Transfer (“SET”) protocol or an appropriate electronic funds transfer protocol. The payment network may be secure (such as through employing encryption techniques, VPNs, and the like), so that the sensitive transactions are not compromised.

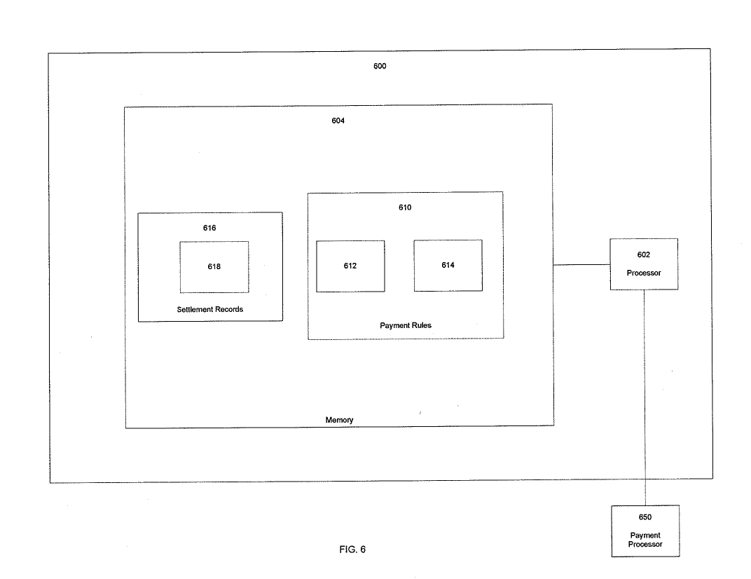

FIG. 6 depicts an exemplary embodiment of the automated payments engine 540 of FIG. 5. The automated payments engine 600 may include a processing arrangement 602 and a memory 604 for carrying out the described techniques. For example, the processing arrangement may be configured with one or more software applications to carry out the described techniques. Processing arrangement 602 may load payment rules 610 from a rules database (not shown) and settlement records 616 from a transaction database (not shown) into memory 604. The payment rules 610 may include one or more payment conditions 612 and one or more payment methods 614. The settlement records 616 may include transaction data 618. The processing arrangement may, for each of the settlement records 616, compare the transaction data 618 therein to the payment condition 612 of the payment rules 610. If a condition is satisfied, the processing arrangement 602 may instruct a payment processor 650 to initiate a payment transaction according to the payment method 614 associated with the satisfied payment condition 612.

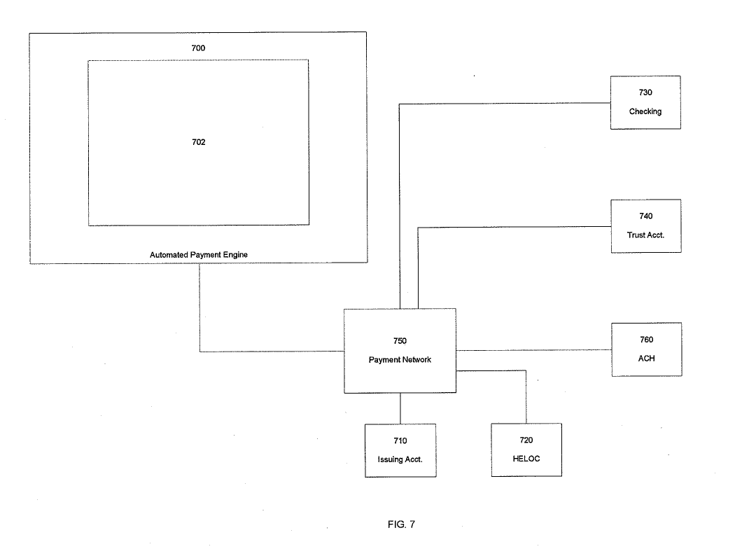

Turning to FIG. 7, an automated payments engine 700 may be connected to a payment network 750 to initiate a payment transaction when processing logic 702 determines a payment method is to be utilized. Banks housing the HELOC account (home equity line of credit) 720, checking account 730, and trust account 740 may also be connected to the payment network 750 for the exchange of funds with issuing bank account 710. In some embodiments, payments may be made through an automated clearing house 760. In some embodiments, the account from which the payments are to be deducted may be with the same banking institution as the accountholder's credit card account.

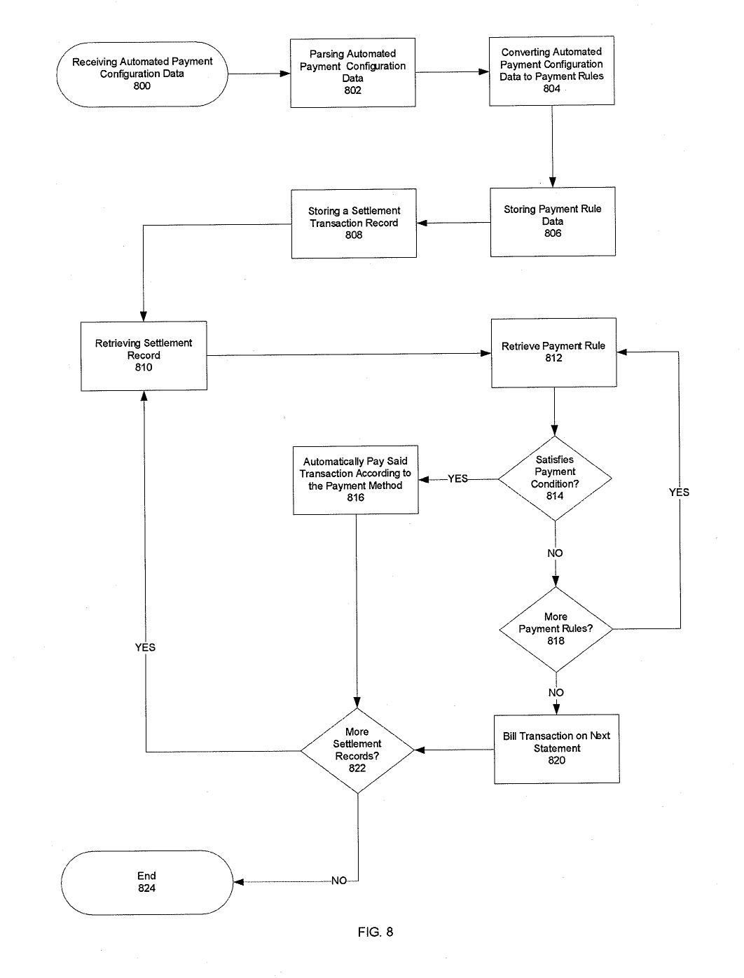

FIG. 8 depicts an exemplary procedure according to some embodiments of the described subject matter. The automated payments engine receives automated payment configuration data (block 800), such as from a cardholder. As described, the automated payment configuration data may be received in response to a request for payment rule data (e.g., when a cardholder wishes to modify an existing rule) or may be new automated payment configuration data (e.g., when a cardholder creates a new payment rule). The automated payment configuration data may be generated by a remote computing device within the control of the cardholder and transmitted over a network to the automated payments engine. The automated payments engine may parse the automated payment configuration data (block 802) and convert the parsed data into payment rules (block 804). For example, the automated payment configuration data may be a string of bytes received in an HTTP post message. The parameters of the HTTP post message may be “field=value” pairs. Each field may correspond to a particular field of a payment condition. For example, the HTTP message may include the substring “dollar_amount=20&above_or_below=below”. The data may be parsed into two variables, “dollar_amount” and “above_or_below” and the corresponding values stored in the variables. Alternatively, the automated payments engine may store the values in an object using the object's “set” methods.

The automated payments engine may generate a payment rule from the parsed data and store the rule in the rules database (block 806).

The automated payments engine may store a settlement transaction record (block 808), such as following the payment of a charge transaction by the user and clearing of the payment. The receipt of the settlement record may be in conjunction with posting the charge to the cardholder's account. The settlement record may be stored in a transaction database and may include various details regarding the transaction that may be used for automated payments.

In some embodiments, the settlement transaction record may include the same number and type of fields as a payment condition. Such a configuration may permit fast comparison of the transaction data with the payment conditions. In other embodiments, the settlement transaction record may be stored in a proprietary format and parsed by the automated payments engine when the data of the record is required.

In some embodiments, the accountholder's account may be a credit card account. For example, charges may be accumulated on the card when the cardholder pays for goods at one or more merchants. Once the charges are authorized and the merchant delivers the goods, charges may be posted to the credit card account. In some embodiments, the charges may reduce the cardholder's credit limit immediately, and when a payment rule is executed and the payment has cleared, the credit limit may be increased accordingly. In other embodiments, the credit limit is reduced when the charge is not automatically paid in accordance with one of the payment rules.

In order to process automated payments, a settlement transaction record may be retrieved from the transaction database (block 810) and a payment rule retrieved from the rules database (block 812).

The automated payments engine may then determine whether the settlement transaction satisfies the payment condition (block 814).

A payment condition can include one or more subconditions. For example, a payment condition may include three subconditions, c1: a dollar amount less than $20, c2: a goods type of home goods, and c3: a purchase date between January 1 and March 1. Likewise, a payment method may include one or more submethods. For example, m1: pay using checking account (ID A123) and m2: pay immediately.

The subconditions and submethods can be logically related to each other using any number of “and” and “or” operators. For example, a payment condition may be (c1 and (c2 or c3)), (c1 and c2 and c3), (c1 or c2 or c3), or ((c1 and c2) or (c2 and c3) or (c1 and c3)). The conditions and methods may also include the “not” operator, such as (not (m1) or m2). Other operators may be used as appropriate, including “within”, “between”, “>”, “<”, and the like. It should be understood that the above notation is for illustrative purposes and that any appropriate techniques for implementing the above concepts may be used.

The automated payments engine may compare the data of the settlement transaction record retrieved to see if it satisfies the payment condition. If so, the automated payments engine may pay the transaction amount using the payment method as specified in the payment rule (block 816). For example, if the payment method states that the transaction is to be paid from a home equity line of credit account (“HELOC”), the payments engine may generate a payment message including the HELOC account ID, the transaction amount to be paid, and the account ID of the card issuer. A header address of the HELOC bank server may be appended to the message, and the message may be transmitted through a payment network to the HELOC bank server. The HELOC bank server may authenticate the message and initiate an EFT transaction to transfer the transaction amount from the HELOC account to the card issuer's account, for example, over the payment network. In some embodiments, where the accountholder's account is a credit card account, completion of the payment of the transaction may result in no reduction of the account's credit limit.

If the settlement transaction does not satisfy the payment rule, then another payment rule may be retrieved. The same procedure may be executed until either the settlement transaction satisfies a payment rule or no more payment rules are left (block 818). If the settlement transaction does not satisfy any payment conditions of the payment rules, the transaction is stored in a database to be billed on the next billing statement (block 820).

The procedure continues until no more settlement records are left (blocks 822 and 824). At the end of the month, all charges which were not paid by the automated payments engine may be collected, printed, and delivered to the user in one section of a billing statement. The charges that were automatically paid may be collected and presented in the bill in a separate section.

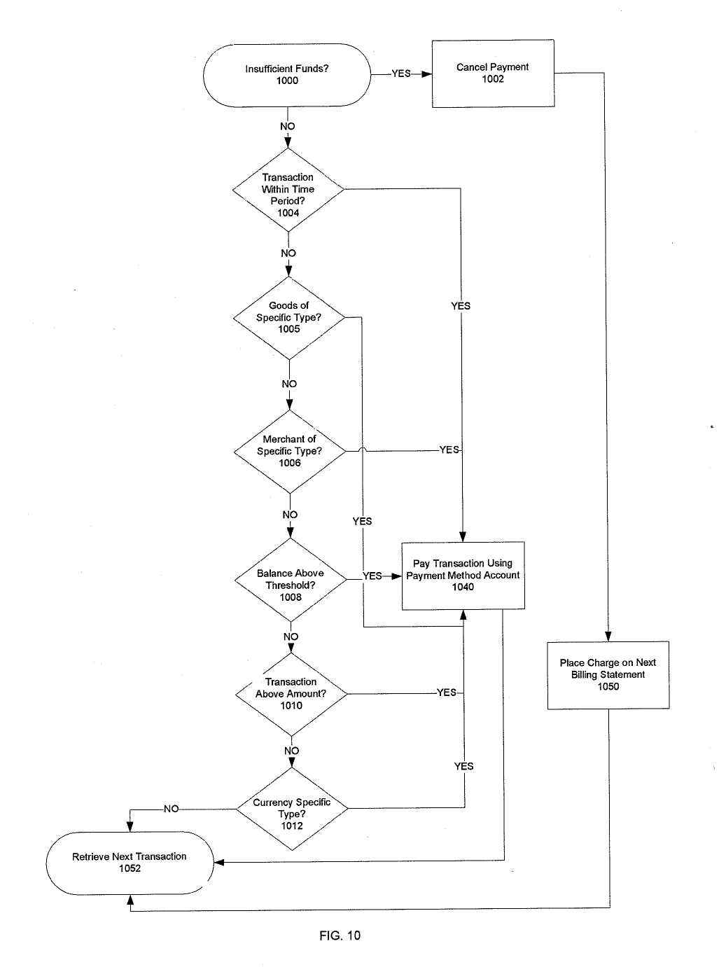

FIG. 10 depicts an exemplary procedure for determining whether a transaction satisfies a payment condition. If the account from which the funds is to be withdrawn to pay the transaction has an insufficient balance (block 1000), then the payment should be canceled (block 1002) and the transaction billed on the next billing statement (block 1050). If the transaction occurred within a specific time period (e.g., between Thanksgiving and New Year's) (block 1004), or the goods purchased are of a specific type (e.g., home goods), or the merchant is of a specific type (e.g., a home goods merchant) (block 1006), or the account from which funds are to be deducted is above a certain threshold (e.g., more than $1000) (block 1008), or the transaction is for an amount above a specific threshold (e.g., $100) (block 1010), or the currency of the transaction is of a specific type (e.g., U.S. dollars) (block 1012), then automatically pay the transaction (block 1040). Otherwise, bill the transaction on the next statement (block 1050) and retrieve the next transaction (block 1052).

The foregoing merely illustrates the principles of the described subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the described subject matter and are thus within the spirit and scope of the described subject matter.

What is claimed is:

1. A system for automatically processing payment transactions associated with a credit card account having a periodic billing cycle, comprising:
an accountholder interface configured to receive automated payment configuration data from an accountholder associated with said credit card account, said configuration data including at least one payment condition and at least one payment method associated with said payment condition;
an account transaction settlement database storing at least one settlement record, said settlement record corresponding to a payment transaction performed using said credit card account; and
an automated payments processing engine, coupled to said accountholder interface and to said account transaction settlement database, said automated payments processing engine configured to determine whether said payment transaction satisfies said payment condition and to automatically initiate payment for said transaction using said at least one payment method before the end of said periodic billing cycle when the result of said determining is that said payment condition is satisfied.

2. The system of claim 1, wherein the payment is cancelled and the transaction is included in the next periodic billing statement when a payment method account of the payment method has insufficient funds to pay the payment.

3. The system of claim 1, wherein the amount of credit available to the holder of said credit card account for subsequent purchases is increased by the amount of said payment when said payment is completed.

4. The system of claim 1, wherein the payment condition includes one or more of a condition based on when a payment transaction occurred, a condition based on where a payment transaction occurred, a condition based on the type of goods purchased, a condition based on the type of merchant from which goods were purchased, a condition based on the amount of funds available in said payment method, a condition based on the amount of a payment transaction, and a condition based on the type of currency used to pay for goods.

5. The system of claim 1, wherein the payment condition includes more than one subcondition.

6. The system of claim 1, wherein the payment method account of the payment method is maintained at the same banking institution as the credit card account.

7. The system of claim 1, wherein the payment method account of the payment method is maintained at a different banking institution as the credit card account and the payment is made using an automated clearing house.

8. A method for processing payment transactions associated with a credit card account having a periodic billing cycle, comprising:
receiving, at a configuration server, automated payment configuration data from an accountholder associated with said credit card account, said configuration data including at least one payment condition and at least one payment method associated with said payment condition;
storing, in an account transaction settlement database, at least one settlement record, said settlement record corresponding to a payment transaction performed using said credit card account; and
processing said at least one settlement record using an automated payments engine executed on one or more processors in accordance with said automated payment configuration data to determine whether said payment transaction satisfies said at least one payment condition and to automatically initiate payment for said transaction using said at least one payment method before the end of said periodic billing cycle when the result of said determining is that said at least one payment condition is satisfied.

9. The system of claim 1, further comprising:
canceling the payment and including the transaction in the next periodic billing statement when a payment method account of the payment method has insufficient funds to pay the payment.

10. The system of claim 1, wherein the amount of credit available to the holder of said credit card account for subsequent purchases is increased by the amount of said payment when said payment is completed.

11. The system of claim 1, wherein the payment condition includes one or more of a condition based on when a payment transaction occurred, a condition based on where a payment transaction occurred, a condition based on the type of goods purchased, a condition based on the type of merchant from which goods were purchased, a condition based on the amount of funds available in said payment method, a condition based on the amount of a payment transaction, and a condition based on the type of currency used to pay for goods.

12. The system of claim 1, wherein the payment condition includes more than one subcondition.

13. The system of claim 1, wherein the payment method account of the payment method is maintained at the same banking institution as the credit card account.

14. The system of claim 1, wherein the payment method account of the payment method is maintained at a different banking institution as the credit card account and the payment is made using an automated clearing house.

15. In a financial transaction payment system comprising a processing unit and an application program executing on the processing unit, a method of conducting a transaction, comprising:
receiving data for the transaction comprising at least a transaction amount, the transaction conducted using a financial transaction card, the financial transaction card having both a credit payment function with a first associated line of credit and an installment loan payment function with a second associated line of credit associated therewith;
retrieving one or more transaction criteria associated with said financial transaction card;
evaluating, by the application program, at least a portion of said data for the transaction against said one or more transaction criteria to select one of said first or second line of credit for processing said transaction;
reducing the amount of credit available for purchases under said second associated line of credit by said transaction amount if the result of said evaluating was that said second line of credit was selected and reducing the amount of credit available for purchases under said first associated line of credit by said transaction amount if the result of said evaluating was that said first line of credit was selected.
